(19) United States
(12) Patent Application Publication
(10) Pub. No.: US 2019/0130778 A1
(43) Pub. Date: May 2, 2019

(54) JURY SELECTION METHOD AND SYSTEM

(71) Applicant: MOMUS ANALYTICS, LLC, Coral Gables, FL (US)

(72) Inventor: Alex Alvarez, Coral Gables, FL (US)

(21) Appl. No.: 16/179,222

(22) Filed: Nov. 2, 2018

Related U.S. Application Data
(60) Provisional application No. 62/580,666, filed on Nov. 2, 2017.

(51) Int. Cl. G09B 7/02; G06Q 50/26; G06Q 50/00

(52) U.S. Cl. CPC G09B 7/02; G06Q 50/01; G06Q 50/26

(57) ABSTRACT

A method and system for selecting a jury may include gathering data on the potential jurors and ranking the jurors using a rating system. The rating system may rate jurors on the personal and sociality responsibility traits as well as a leadership traits. Depending on the type of case to be tried, and which side of the case the user attorney is representing, the juror may be rated and ranked so as to assist the user with selecting a favorable jury. Data for the rating system may be acquired through the voir dire process and questionnaires received from the potential jurors as well as through network searches through publicly available resources, such as an internet search for a potential juror's social media page.

### CROSS REFERENCE TO RELATED APPLICATIONS

This application claims priority to U.S. provisional application No. 62/580,666 filed on Nov. 2, 2017, the entire contents of which are hereby incorporated by reference.

### FIELD OF THE DISCLOSURE

This disclosure relates generally to methods, systems and software for selecting a jury.

### BACKGROUND

Jury trials are unique legal proceedings which evolved from common law systems and are, in many instances, constitutionally guaranteed as part of the United States legal system. A jury will consist of a group of individuals tasked with making findings of fact in a legal dispute. Jurors can be selected from a diverse background of applicants, and selecting favorable jurors can be critical to obtaining a favorable jury verdict. Selecting a jury from a pool of candidates is accomplished through a voir dire system, whereby counsel will ask jurors a series of questions in order to discover each juror's background as well as to elicit possible biases the juror may hold. The voir dire system can be challenging given the very short time frame in which an attorney has to interview the jurors. Attorneys are often given as little as thirty minutes or less to conduct the voir dire process. Challenges are available to each party in order to disqualify a juror, either for cause or without cause, depending on the biases the juror reveals. The number of challenges available varies by jurisdiction, but no matter the number they are typically finite. Accordingly, a method or system to quickly evaluate a juror's background for possible biases, within the short timeframe provided for voir dire, would be beneficial to an attorney seeking to select a favorable jury panel with a limited number of challenges available.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one embodiment of the disclosure, a method for selecting a jury from a plurality of potential jurors may include collecting an initial set of biographical data from a jury pool from questionnaires and answers by potential jurors through voir dire, storing the initial set of biographical data on a jury selection module operating on a portable multifunction device, conducting a search that includes using the jury selection module and the initial set of biographical data to identify and acquire a second set of biographical data from publicly available resources provided on a network, and analyzing the initial and second sets of biographical data in order to generate a juror rating.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIG. 1 illustrates a diagram of a portable multifunction device.

FIG. 2 illustrates a diagram of a portable multifunction device with a jury selection module.

FIG. 3 illustrates an architectural diagram of jury selection module.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

The various embodiments and/or components, for example, the modules, elements, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

In one embodiment, a method for selecting a jury from a plurality of potential jurors may include collecting an initial set of biographical data from a jury pool from questionnaires and answers by potential jurors through voir dire, storing the initial set of biographical data on a jury selection module operating on a portable multifunction device, conducting a search that includes using the jury selection module and the initial set of biographical data to identify and acquire a second set of biographical data from publicly available resources provided on a network, and analyzing the initial and second sets of biographical data in order to generate a juror rating.

In further embodiments of a method for selecting a jury, the juror rating may include a leadership rating representing the likelihood one potential juror might influence other potential jurors during a deliberation. The leadership rating may be classified as strong, weak, or neutral. The leadership rating may be determined from analyzing at least one of the following datum: the potential juror's occupation, political affiliation, or education. The juror rating may include a numerical rating and as part of the numerical rating a relatively low value may be indicative of strong personal responsibility and a relatively high value may be indicative of strong social responsibility. The numerical rating may be determined from analyzing at least one of the following datum: the potential juror's religion, political affiliation, status as an active voter, or status as a business owner. Conducting the search may include identifying at least one social media page affiliated with at least one potential juror and mining data from the at least one social media page. The analyzing may include comparing the initial and second sets of biographical data for discrepancies. The method may further include using the juror ratings to select a jury, recording the jury verdict on the jury selection module, transmitting the jury verdict and the initial and second biographical data sets to a central server, comparing the jury verdict and the initial and second biographical data sets with at least one additional jury verdict and associated set of data, and instructing the jury selection module to adjust its generating of a juror rating.

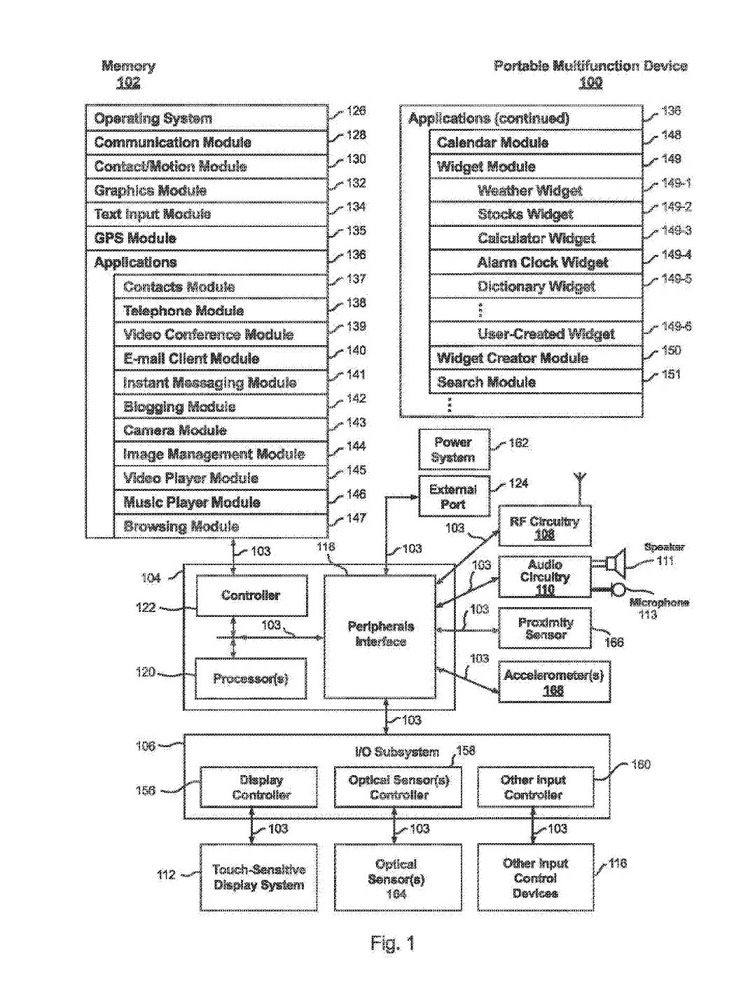

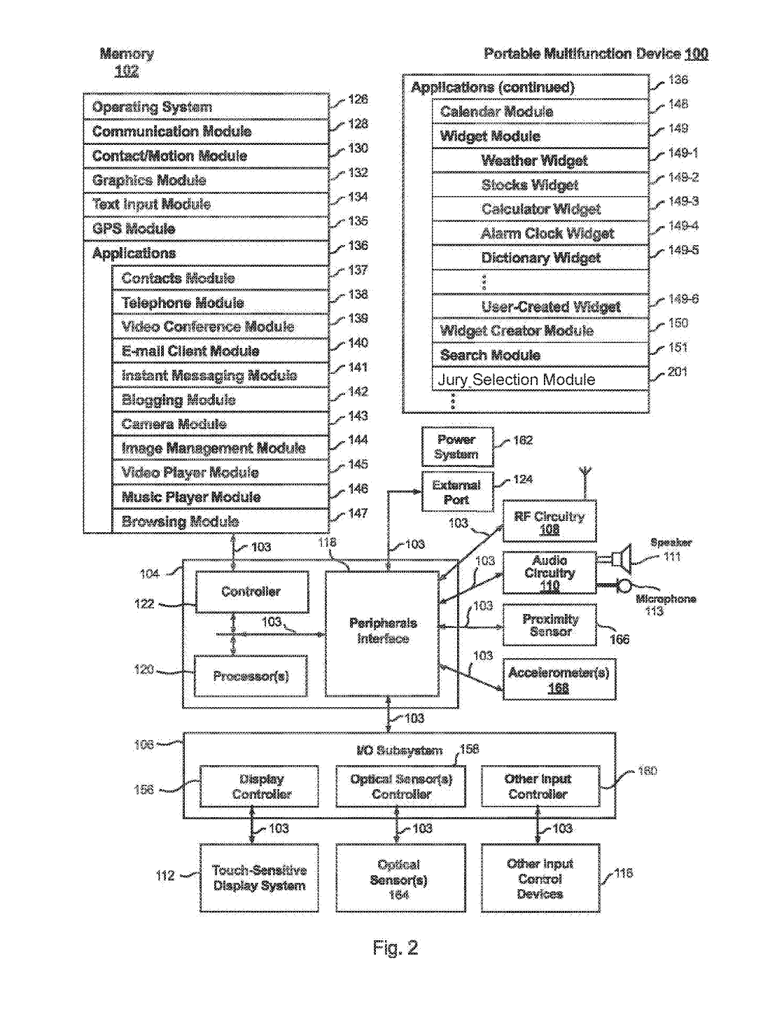

FIGS. 1 and 2 are block diagrams illustrating exemplary prior art portable multifunction devices 100 with touch-sensitive displays 112 modified to include the applications of the present invention. The touch-sensitive display 112 is also known in the art as a touch screen or a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

The device 100 is only one example of a portable multifunction device 100 that may be used to execute the applications of the present invention, and that the device 100 may have more or fewer components than shown, may combine two or more components, or a may have a different configuration or arrangement of the components. The various components shown in FIGS. 1 and 2 may be implemented in hardware, software or a combination of both hardware and software, including one or more digital signal processing (“DSP”) circuits and/or application specific integrated circuits (“ASICs”).

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

The peripherals interface 118, the CPU 120, and the memory controller 122 may be implemented on a single chip, such as a chip 104. They may also be implemented on separate chips.

The transceiver circuitry 108 receives and sends electromagnetic signals. A person of ordinary skill in the art would recognize that these signals are conventionally referred to as radio frequency (“RF”) signals in the context of portable devices, regardless of whether the signals fall within what is conventionally known as the radio spectrum. The term transceiver circuitry and RF circuitry will be used interchangeably in the present application.

The RF circuitry 108 converts electrical signals to/from electromagnetic signals and communicates information to and from communications networks and other communications devices by modulating/demodulating electromagnetic signals with data corresponding to the information. The RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. The RF circuitry 108 may communicate with networks, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this application.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. The audio circuitry 110 may also include a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”).

A touch screen 112 has a touch-sensitive surface, sensor or set of sensors that accepts input from the user through tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. For example, a point of contact between a touch screen 112 and the user corresponds to a finger of the user.

The touch screen 112 may use LCD (liquid crystal display) technology, or LPD (light emitting polymer display) technology, although other display technologies may also be used. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1 and 2 show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. The optical sensor may be located on the back of the device 100, opposite the touch screen display 112 on the front of the device, so that the touch screen display may be used as a viewfinder for either still and/or video image acquisition. An optical sensor may also be located on the front of the device so that the user's image may be obtained for videoconferencing while the user views the other video conference participants on the touch screen display. Preferably, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1 and 2 show a proximity sensor 166 coupled to the peripherals interface 118. Alternately, the proximity sensor 166 may be coupled to an input controller 160 in the I/O subsystem 106. The proximity sensor 166 may be used to turn off and disable the touch screen 112 when the multifunction device is placed near the user's ear (e.g., when the user is making a phone call). The proximity sensor can also be used to keep the screen off when the device is in the user's pocket, purse, or other dark area to prevent unnecessary battery drainage when the device is a locked state.

The device 100 may also include one or more accelerometers 168. FIGS. 1 and 2 show an accelerometer 168 coupled to the peripherals interface 118. Alternately, the accelerometer 168 may be coupled to an input controller 160 in the I/O subsystem 106. The accelerometer 168 captures data that is analyzed to determine whether to change a view of information, for example from portrait to landscape, displayed on the screen of the portable device.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively the contact/motion module 130 and the controller 160 detects contact on a click wheel, for example.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module 152, which merges video player module 145 and music player module 146; notes module 153; and/or map module 154; and/or online video module 155.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it easy to create and send e-mails with still or video images taken with camera module 143.

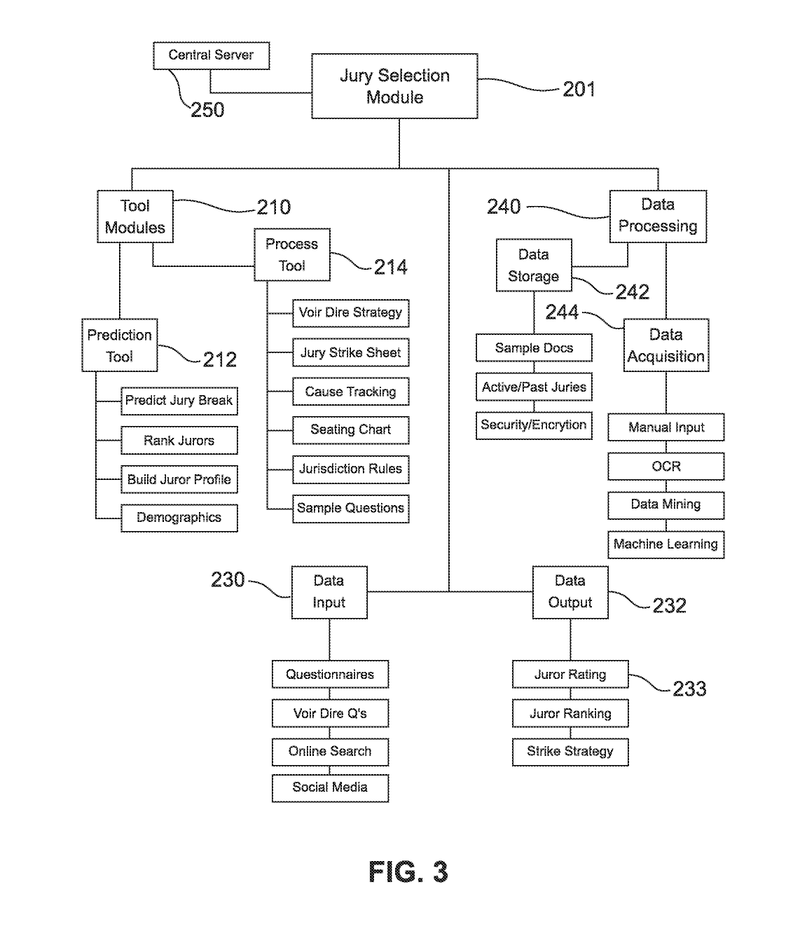

In conjunction with RF circuitry 108, touch screen 112, display controller 156, contact module 130, graphics module 132, and text input module 134, the jury selection module 201 may be used to connect individual users with other individuals or entities as will be described below with reference to FIG. 3. In one embodiment, the jury selection module 201 may be implemented as a widget.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In other modes of operation, instant messaging module 141, rather than e-mail client module 140, is used to send a link to a particular online video.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 2). Memory 102 may store a subset of the modules and data structures identified above. Furthermore, memory 102 may store additional modules and data structures not described above.

The device 100 may be a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

With reference to FIG. 3, an architectural diagram is shown illustrating functional blocks for embodiments of a jury prediction module 201 operable on a portable multi-function device 100, such as a mobile device or laptop. A variety of tool modules 210 may be operable as part of the jury prediction module 201 including a prediction tool 212 and a process tool 214.

The prediction tool 212 may include: a prediction for jury break; a ranking of jurors to be continuously updated in real-time as data is input; building juror profiles; and a compilation of demographics data for potential jurors. The process tool 214 may include: a proposed voir dire strategy based on the case type and initial data obtained regarding the jury pool in advance of voir dire; a jury strike sheet; a juror for-cause strike sheet; a seating chart of the jurors; a reference for procedural rules specific to the jurisdiction the trial is taking place; video material of information relevant to the voir dire process; and sample jury questionnaires specific to the type of case, region the trial is in, etc.

Data input 230 may include: juror demographics such as voter registration, age, and opinions on certain topics; juror provided information in response to a questionnaire provided to the juror, which may be processed with an optical character reader (OCR); the juror's social media accounts, including through key word searching and other methods of manually or automatically data mining a juror's social media accounts; answers to voir dire questions that are particularly designed to discover biases related to a particular type of case; and trial transcripts available for each juror. Data output may include: a juror rank, as disclosed herein; a juror cause justification tracking; an overall percentage score of good versus bad for particular categories of data; a proposed juror strike strategy; and a final proposed jury and alternate jurors to be employed in the event that a seated juror is excused or disqualified.

Data processing 240 occurring as part of the selection module 201 may be performed on a local processor and database, on a cloud based or software as a service (“SaaS”) system, or a combination thereof. In embodiments with a cloud based or SaaS system, a central computer may be able to communicate with a plurality of local computer systems in order to constantly update predicative algorithms and adjust database measurements as may be applicable for other cases, either ongoing or yet to occur. Data storage 242 may occur through local memory 102 or on a cloud based system. Data stored may also be secured through known or to be developed encryption protocols. Data acquisition 244 may occur through manual input by a user, analytical processor engines with machine learning features, variable strengths, text mining tools, and relationship interactions.

Given the short time frame in which a jury voir dire occurs, data acquisition 244 may occur in real-time and be machine reliant in data acquisition. For instance, jurors may submit questionnaires with certain base line biographical and demographic data. This baseline data may be inputted manually by a user or automatically, for instance by OCR in coordination with camera module 143. Additional data may be acquired in reliance on portable multifunction device 100. For instance, data mining may occur in coordination with communication module 130. Potential jurors may be identified through internet searches of social media and other biographical data bearing websites. Through known or to be discovered methods of data mining, a potential juror may be identified on a social media platform, and data mining tools may be utilized to pull additional categories of information as contemplated within this disclosure. Internet search engines may also be utilized to acquire information for other data sources such as blogs, news articles, directories, business webpages, etc. Data acquired may then be manipulated in real time through computer machine learning so as to resolve conflicts in data acquired, such as voir dire answers inconsistent with data discovered through a social media platform. Moreover, process tool 214 may include an alert function to indicate a juror may not have been truthful in a questionnaire or voir dire response based on inconsistencies with independently discovered data. Similarly, the juror's veracity may be taken into consideration as part of the juror rating 233 as described herein.

The jury selection module 201 may operate on a tablet, computer or mobile device and include a variety of graphical user displays to assist with input and output of data. Display pages as part of the module may include: visual seating charts; a main juror page; a voir dire page with question and answering tracking; and a constant or substantially constant landscape. Because a large amount of information may need to be gathered quickly in a voir dire setting, minimalistic interfaces may be developed to reduce complexity and increase efficiency for use of the module.

A juror ranking or classification system 233 may be developed to assist with the selection of favorable jurors. Based on input data, each juror may be scored based upon or associated with one or more of the following traits: leadership; social responsibility; and personal responsibility. Each trait may be given a regression curve based on data obtained which would affect the scoring of each trait. Traits receiving a regression score of greater than 0.5 may be rounded to a 1 for representing a particular trait as part of juror classification, while a regression score of 0.5 or less may be rounded to a 0 for representing an absence of a trait as part of juror classification. An alpha numeric classification for each juror may be generated depending on the traits identified for each juror. In one embodiment a juror classification may be based on scores for Leadership [0,1], Social Responsibility [0,1], and Personal Responsibility [0,1]. Potential jurors may be scored into the following classifications based on trait store: 1 [1,0,1]; 2 [0,0,1]; 3 [0,0,0]; 3L [1,0,0]; 4 [0,1,0]; and 5 [1,1,0]. Notably in this classification system, a potential juror may have a trait of personal responsibility, social responsibility, or neither, but not both. The highest and lowest scores are reserved for individuals expressing a leadership trait accompanied with either a social or personal responsibility trait, while a person experiencing neither a social nor personal responsibility trait, or alternatively is well balanced between social and personal responsibility traits, is either a neutral 3 or a 3L if they show a leadership trait.

In another embodiment of a classification system 233 to be used with a jury selection method, classifications may be assigned to show degrees of responsibility and leadership traits. For instance, an initial classification may be provided as follows: 1=personal responsibility and leader; 2=personal responsibility and follower; 3=neutral follower; 4=social responsibility and follower; and 5=social responsibility and leader. A classification of 3L may be a neutral leader. Further alphabetic categorization may be assigned to show “strong,” “medium,” or “weak” degrees or leaning for both leadership traits and responsibility traits. The below chart demonstrates such an embodiment of this classification system.

TABLE 1
Juror Rating

| | Strong | Medium | Weak | Strong | Medium | Weak | Strong | Medium | Weak |
|---|---|---|---|---|---|---|---|---|---|
| Initial Classification | Leader | Leader | Leader | PR | PR | PR | SR | SR | SR |
| 1 = PR & Lead | 1 S | 1 M | 1 W | 1-S | 1-M | 1-W | n/a | n/a | n/a |
| 2 = PR & Follow | n/a | n/a | n/a | 2-S | 2-M | 2-W | n/a | n/a | n/a |
| 3 = Neutral & Follow | n/a | n/a | n/a | 3-1 S | 3-1 M | 3-1 W | 3-5 S | 3-5 M | 3-1 W |
| 3 L = Neutral & Leader | 3 L-S | 3 L-M | 3 L-W | 3 L-1 S | 3 L-1 M | 3 L-1 W | 3 L-5 S | 3 L-5 M | 3 L-5 W |
| 4 = SR & Follow | n/a | n/a | n/a | n/a | n/a | n/a | 4-S | 4-M | 4-W |
| 5 = SR & Lead | 5 S | 5 M | 5 W | n/a | n/a | n/a | 5-S | 5-M | 5-W |

Moreover, leadership and responsibility trait strengths or tendencies can be shown where the first alphabetical indicator for “S,” “M,” or “W” indicates how strong of a person with a leadership trait is demonstrating the leadership trait, while a second alphabetical indicator for “S,” “M,” or “W” indicates the strength of the person's responsibility trait. For example, a 3S-5S is a neutral leader who is showing strong leadership traits and a heavy showing of SR signals despite being classified an overall 3. As another example, a 3 W-1 W is a neutral leader showing weak leadership traits and a weak or low strength PR signals despite being classified as an overall 3. As a further example, a 1S-M shows strong leadership trait with medium PR signals. In some embodiments, the 2 and 4 classifications could be eliminated and simply replaced in consideration of a showing of a strength indicator of leadership traits, since those classifications are reserved for followers.

Factors determining whether a potential juror is considered a leader tend to evidence whether the juror would influence other juror's decision during deliberation. Accordingly, the leadership trait would result in each juror characterized as either a leader or follower. Responsibility traits can accordingly be characterized as either social, personal, or neutral.

A data matrix may be developed based on inputted data 230. Input data may include: age; sex; race; nationality; education; profession; political affiliation; active voter; business owner; religion; social issues; political issues; military background; membership with advocacy groups; smoker; animal rights supporter; environment supporter; opinion of jury service; hobbies; support for the arts; lifestyle and related habits; volunteer status; attitudinal responses to direct questioning (e.g. too many frivolous lawsuits, problem with punitive damages, bias against attorneys, etc.); and responses with respect to the specific parties. From these data points, a classification may be assigned based on leadership and responsibility traits associated with these data points.

Leadership traits can be utilized to determine the likelihood of how influential a particular juror would be to the other jurors during deliberation. Accordingly, a ranking criteria may place extra emphasis on jurors given a 1, 3L, or 5 rating. Attributes which may indicate a likelihood of a leadership trait may include, in order of weight or importance to indicating a leadership trait: supporting animal rights groups; US postal service as a profession; profession as a social worker; profession in firefighting; alliance with negative social issues; race as Asian; profession as physician; politically progressive; profession as a hospital administrator; profession in child care; politically affiliated with the Democratic party; being a small business owner; having a master's level or higher of education; having a south or central American nationality; profession as a cashier; supporter of the NRA or hunting; and profession in nursing. Attributes which may indicate a unlikelihood of a leadership trait may include, in order of weight or importance indicating a follower trait: profession in engineering; profession in farming or ranching; profession in accounting; profession in acting or dancing; profession in bartending; profession as boat captain or airplane pilot; profession as digital or graphic artist; attitude of not believing in lawsuits; profession in business consulting; profession in social work; education less than high school; profession as low level medical support staff; race defined as other; profession in construction; profession in police; education of bachelor's degree; education of high school degree; and profession as paramedic. Overall, data which may be most likely to influence identification of a leadership or follower trait may be, in order of importance or weight: profession as US postal service; supporting animal rights; profession as engineer; political affiliation as democrat; political affiliation as not declared; profession as accountant; profession as customer service; profession in nursing; profession as social worker; attitude of not believing in lawsuits; small business owner; profession as low level medical support; profession as business consultant; profession in firefighting; profession in transportation; and profession as physician.

After a jury verdict has been received, past juror rankings and results may be stored and analyzed as part of selection module 201. These results may be communicated with a central server 250 in communication with a plurality of jury selection modules 201 employed by different users. Results may be centrally analyzed to develop success statistics as well as to propose algorithm updates to prediction tool 212 in developing juror rankings 233. In this regard, jury selection module 201 is continuously learning in order to optimize juror rating 233 criteria and weight given to the various data inputted.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

What is claimed:

1. A method for selecting a jury from a plurality of potential jurors, the method comprising:
collecting an initial set of biographical data from a jury pool from questionnaires and answers by potential jurors through voire dire;
storing the initial set of biographical data on a jury selection module operating on a portable multifunction device;
conducting a search, wherein the conducting comprises using the jury selection module and the initial set of biographical data to identify and acquire a second set of biographical data from publicly available resources provided on a network; and
analyzing the initial and second sets of biographical data in order to generate a juror rating.

2. The method of claim 1, wherein the juror rating includes a leadership rating representing the likelihood one potential juror might influence other potential jurors during a deliberation.

3. The method of claim 2, wherein the leadership rating is classified as strong, weak, or neutral.

4. The method of claim 2, wherein the leadership rating is determined from analyzing at least one of the following datum: the potential juror's occupation, political affiliation, or education.

5. The method of claim 1, wherein the juror rating includes a numerical rating and as part of the numerical rating a relatively low value is indicative of strong personal responsibility and a relatively high value is indicative of strong social responsibility.

6. The method of claim 5, wherein the numerical rating is determined from analyzing at least one of the following datum: the potential juror's religion, political affiliation, status as an active voter, or status as a business owner.

7. The method of claim 1, wherein conducting the search includes identifying at least one social media page affiliated with at least one potential juror and mining data from the at least one social media page.

8. The method of claim 1, wherein the analyzing includes comparing the initial and second sets of biographical data for discrepancies.

9. The method of claim 1 further comprising:
using the juror ratings to select a jury;
recording the jury verdict on the jury selection module;
transmitting the jury verdict and the initial and second biographical data sets to a central sever;
comparing the jury verdict and the initial and second biographical data sets with at least one additional jury verdict and associated set of data; and
instructing the jury selection module to adjust its generating of a juror rating.
